(19) United States
(12) Patent Application Publication
(10) Pub. No.: US 2001/0004268 A1
(43) Pub. Date: Jun. 21, 2001

(54) Digital camera

(76) Inventors: Hiroaki Kubo, Muko-Shi (JP); Yasuhiro Morimoto, Takatsuki-Shi (JP)

Correspondence Address: SIDLEY & AUSTIN, 717 NORTH HARWOOD, SUITE 3400, DALLAS, TX, 75201, US

(21) Appl. No.: 09/735,751

(22) Filed: Dec. 13, 2000

(30) Foreign Application Priority Data
Dec. 14, 1999 (JP) 11-354152

(51) Int. Cl. H04N 5/76; H04N 5/222

(52) U.S. Cl. 348/333.02; 348/233; 348/333.05

(57) ABSTRACT

A digital camera in which two recording media such as memory cards may be mounted, wherein when an image 211 is reproduced in the monitor 21 on the rear side of the camera, the card name 212 for the memory card in which the data for the image 211 is recorded, as well as the image number 213, are also displayed. Further, by deeming the first image data item in the other memory card as the image data item following the last image data item in one memory card, all image data items recorded in both memory cards are handled as if they were recorded in a single large-capacity memory card. Consequently, the user may easily determine the memory card from which the displayed image was read, and at the same time, erroneous operation may be prevented, and accurate handling of the image data may be realized.

This application is based on application No. Hei 11-354152 filed in Japan, the content of which is hereby incorporated by reference.

### BACKGROUND OF THE INVENTION

1. Field of the Invention

The present invention pertains to a digital camera that obtains image data regarding an object through photographing.

2. Description of the Prior Art

In a digital camera, image data obtained through photographing is generally recorded in the recording medium comprising a detachable memory card or internal memory. In recent years, digital cameras in which two recording media, such as memory cards, may be mounted have become available in the market.

In the case of a digital camera in which two recording media may be used, the recording medium to be used for writing the image data, or the recording medium from which data should be read, must be determined in advance, and such camera is equipped with a switch used to alternate the recording medium to be accessed.

However, simply alternating by means of the alternating switch the recording medium to be accessed may lead the operator to mistakenly identify the recording medium being used for the current operation, and may result in unintended deletion of image data.

For example, in a digital camera in which two memory cards may be mounted, if the available space in the memory card being used to record image data obtained through photographing runs out, switching to the different memory card takes place, and the image data obtained during the next photographing session is recorded in the other memory card. In this case, similar items of image data are recorded in both memory cards, and therefore the operator must pay close attention when managing the image data.

### SUMMARY OF THE INVENTION

The present invention was made in view of the problems identified above. Its object is to realize accurate handling of image data in a digital camera equipped with two or more recording media such as internal memory or memory cards.

A first aspect of the invention comprises a digital camera that obtains and records image data through photographing, the digital camera having a reader that can read image data from two or more recording media, a display that performs display of the image, and a display controller that causes the display to display the information that specifies the recording medium from which the image data was read as well as the image based on the image data.

Another aspect of the invention comprises a digital camera that obtains and records image data through photographing, the digital camera having a reader that reads image data from a first recording medium or a second recording medium, a display that performs display of the image, and a display controller that causes the display to display essentially simultaneously a first image based on the image data read from the first recording medium and a second image based on the image data read from the second recording medium.

Yet another aspect of the invention comprises a digital camera that obtains and records image data through photographing, the digital camera having a reader that can read image data from any of two or more recording media, a display that performs display of the image, and a display controller that, by handling a plurality of items of image data recorded in the two or more recording media in sequence based on a prescribed rule, causes the display to sequentially display the plurality of images in accordance with the sequence.

Yet another aspect of the invention comprises an image display method in a digital camera, in which image data is read from one of two or more recording media, and an image based on the image data and the information that specifies the recording medium from which the image data was read are displayed.

Yet another aspect of the invention comprises an image display method in a digital camera, in which image data is read from a first recording medium and a second recording medium, and the first image based on the image data read from the first recording medium and the second image based on the image data read from the second recording medium are displayed essentially simultaneously.

Yet another aspect of the invention comprises an image display method in a digital camera, in which one item of image data is read from a plurality of items of image data stored in two or more recording media, an image is displayed based on the one item of image data, the next item of image data following the displayed item of image data is specified in accordance with the sequence of the plurality of items of image data based on a prescribed rule when the image following the displayed image is designated, and the image data item prior to the displayed item of image data is specified in accordance with said sequence when the image prior to the displayed image is designated.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a front elevation of a digital camera which is one embodiment of the present invention.

FIG. 2 is a rear view of the digital camera shown in FIG. 1.

FIG. 3 is a plan view of the digital camera shown in FIG. 1.

FIG. 4 is a side elevation of the digital camera shown in FIG. 1.

FIG. 5 is a cross-sectional view of the digital camera shown in FIG. 1.

FIG. 6 is a block diagram showing the functional construction of the digital camera shown in FIG. 1.

FIG. 7 is a drawing showing a display example of the camera function display of the digital camera shown in FIG. 1.

FIG. 8 is a simplified drawing showing the data construction inside a memory card.

FIG. 9 is a drawing showing an example of the display in the monitor of the digital camera shown in FIG. 1 when the single image display mode is activated.

FIG. 10 is a flow chart showing an example of the sequence of the operation of the digital camera shown in FIG. 9 when the single image display mode is activated.

FIG. 11 is a flow chart showing the flow of the R key step in FIG. 10.

FIG. 12 is a flow chart showing the flow of the L key step in FIG. 10.

FIG. 13 is a drawing showing an example of the display in the monitor of the digital camera shown in FIG. 1 when the dual image display mode is activated.

FIG. 14 is a drawing showing another example of the display in the monitor of the digital camera shown in FIG. 1 when the dual image display mode is activated.

FIGS. 15 and 16 are flow charts showing an examples of the sequence of the operation of the digital camera when the dual image display mode shown in FIG. 13 or FIG. 14 is activated.

FIG. 17 is a flow chart showing another example of the sequence of the operation of the digital camera when the single image display mode is activated.

FIG. 18 is a flow chart showing another example of the sequence of the operation of the digital camera when the dual image display mode is activated.

FIG. 19 is a drawing showing an example of the display of thumbnail images.

FIG. 20 is a drawing showing another example of the display of thumbnail images.

FIG. 21 is a drawing showing yet another example of the display of thumbnail images.

### DETAILED DESCRIPTION OF THE PREFERRED EMBODIMENTS

<1. First Embodiment>

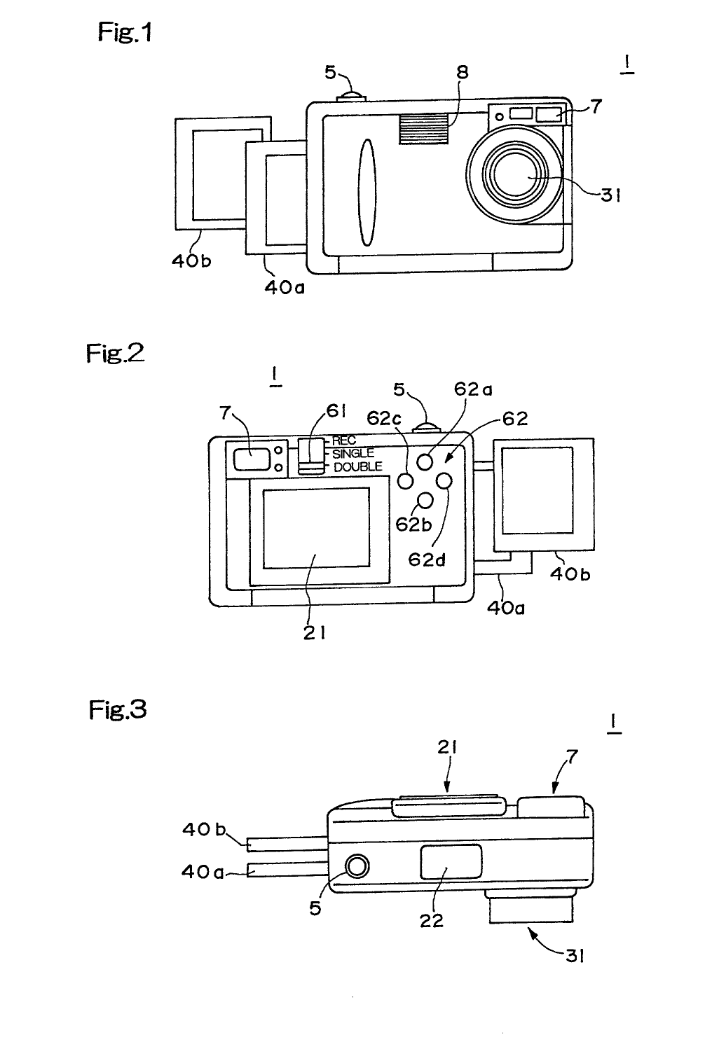

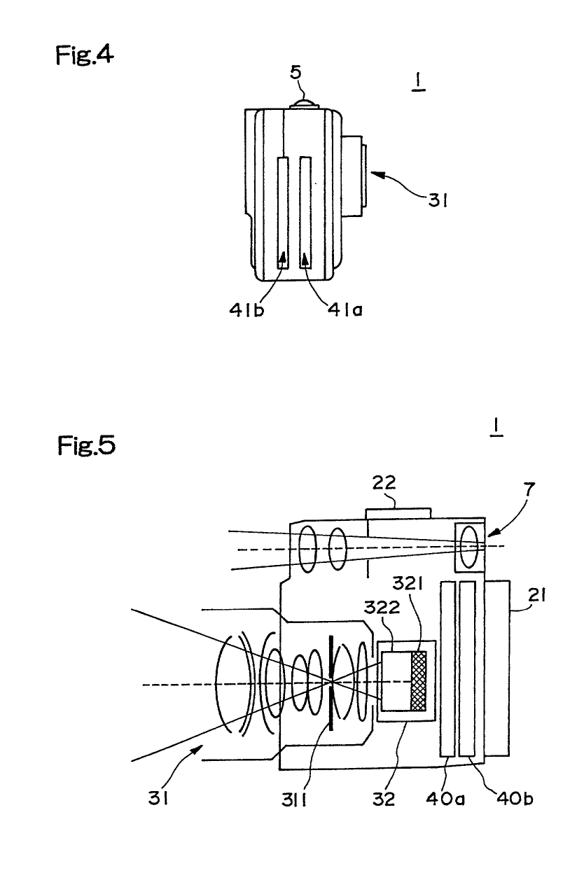

FIGS. 1 through 4 show a first embodiment of the present invention, and show the external view of a digital camera 1. FIGS. 1 through 3 show the digital camera 1 in a manner that reveals how the memory cards 40a and 40b may be mounted to the camera, while FIG. 4 does not show the memory cards.

As shown in FIGS. 1 through 4, a lens unit 31 to perform photographing of an object and an electronic flash 8 to emit flash light toward the object are located on the front side of the digital camera 1, while a monitor 21 having a pixel display-type liquid crystal display to display the recorded image and real-time live view images of the object, an alternating switch 61 to switch the operation mode between photographing mode and reproduction mode, and four-way keys 62 to change the display image or to change the various parameters, are located on the rear side of the camera. An optical finder 7 to determine the photographing area is located on the top side of the digital camera 1.

For the reproduction modes, the digital camera 1 has a single image display mode in which one image is displayed in the monitor 21, and a dual image display mode in which two images are displayed, as described below. The alternating switch 61 comprises a three-point switch that performs mode changing among the photographing mode, the single image display mode and the dual image display mode. In FIG. 2, the keys comprising the four-way keys 62, i.e., the top, bottom, left and right keys, are indicated by the numbers 62a, 62b, 62c and 62d, respectively.

A shutter start button (release button) 5, which initiates photographing of the object when pressed down, and a camera function display 22 that displays the photographing parameters of the digital camera 1 in a simplified fashion, are located on the top side of the digital camera 1. The camera function display 22 comprises a segment display-type liquid crystal display, and by locating it separately from the monitor 21, which is used to confirm the image, the user can visually confirm the parameters during photographing.

Furthermore, as shown in FIG. 4, two card slots 41a and 41b are located on one side of the digital camera 1, such that one memory card may be mounted in each of the card slots 41a and 41b.

FIG. 5 is a basic cross-sectional view showing the interior construction of the digital camera 1. As shown in FIG. 5, the lens unit 31 and the image capture unit 32 are located in that order from the front side toward the interior of the digital camera 1. Through this construction, the image signals regarding the object obtained through the lens unit are received. The lens unit 31 comprises various lenses and an aperture stop 311 that controls the amount of light, and the image capture unit 32 comprises an image pick up sensor 321 on which the object image is formed by means of the lens unit 31, and an optical low pass filter 322 that is located in front of the image pick up sensor 321 and reduces the moire.

The image pick up sensor 321 comprises an all pixel reading type CCD area sensor that has multiple pixels within a plane (image pick up surface) vertical to the optical axis. Red (R), green (G) and blue (B) primary color filters are attached to each pixel on the image pick up surface of the image pick up sensor 321 in a checkered pattern, so that each pixel obtains a stimulus value for each color component of the light that strikes it via the lens unit 31. In the image pick up sensor 321, the exposure amount is adjusted to an appropriate level by controlling the charge accumulation time (i.e., the shutter speed).

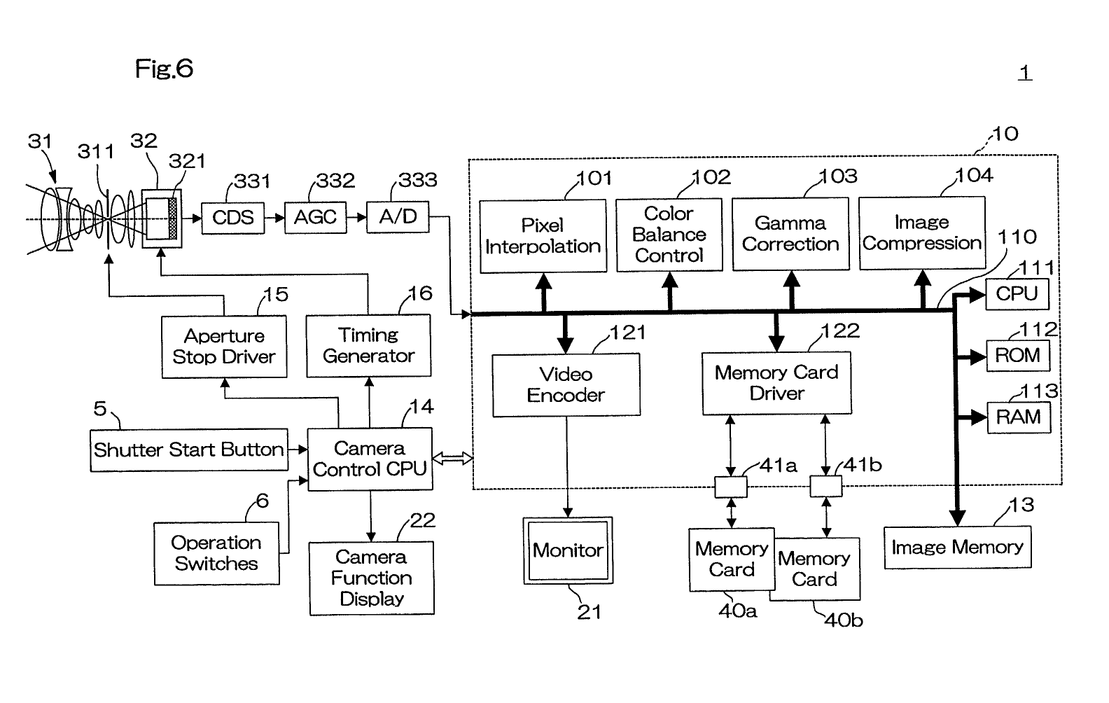

The functional construction of the digital camera 1 will now be explained. FIG. 6 is a block diagram showing the functional construction of the digital camera 1.

The image that has undergone photoelectric conversion inside the image pick up sensor 321 is shifted to the transfer path, which is located inside the image pick up sensor 321 and shielded from light, and is then sequentially read on a pixel-by-pixel basis from this transfer path via a buffer. The image signal obtained by means of the image pick up sensor 321 is led to the image processor 10 via a correlated double sampling circuit (CDS) 331, an auto-gain controller (AGC) 332 and an A/D converter 333. In other words, the image signal is sampled in the CDS 331 and the noise from the image pick up sensor 321 removed, and sensitivity correction is then performed in the AGC 332. The A/D converter 333 comprises a ten-bit A/D converter, for example, and converts the normalized analog signal obtained from the AGC 332 into a digital signal.

As described above, in the digital camera 1, the lens unit 31, image capture unit 32 and circuits 331 through 333 that perform processing of the received image signal function as a photographing structure that obtains the digital image signals of the object image (i.e., image data). In the explanation that follows, a block (stream) of data that corresponds to one image is simply referred as image data, while blocks of image data corresponding to two or more images are termed multiple items (a plurality items) of image data.

In order to control the various mechanisms as well as the various circuits of the digital camera 1 during photographing, the camera has a camera control CPU 14, which transmits control signals to the aperture driver 15 and timing generator 16. The operation of the camera control CPU 14 is different depending on whether the camera is used for a live view session, in which image capture by the image pick up sensor 321 is formed continuously and the image is displayed on an essentially real-time basis in the monitor 21, or an actual photographing, in which image capture is performed for recording purposes.

During a live view session, the aperture stop 311 is fixed in the open position by the aperture driver 15. Exposure control data is calculated by the camera control CPU 14 based on the light amount data from the photometric area on the image pick up sensor 321, and feedback control is carried out based on the exposure control data and a program chart prepared in advance such that the accumulation time regulated by the timing generator 16 becomes optimal.

On the other hand, during an actual photographing session, the aperture value for the aperture stop 311 and the accumulation time for the image pick up sensor 321 are sought by the camera control CPU 14 based on the exposure control data and program chart. Based on the obtained results, the camera control CPU 14 transmits control signals to the aperture driver 15 and timing generator 16, so that the exposure amount during actual photographing is appropriately controlled. In other words, the aperture driver 15 drives the aperture stop 311 based on the control signals from the camera control CPU 14 to adjust the aperture diameter, and the timing generator 16 controls the timings to start and end the charge accumulation performed by the image pick up sensor 321 based on the control signals from the camera control CPU 14.

The camera control CPU 14 is also connected to the shutter start button 5, the alternating switch 61 and the four-way keys 62 (the operation switches other than the shutter start button 5 will be collectively called the ‘operation switches 6’). The operation timing is input to the camera control CPU 14 by means of the shutter start button 5, and various parameters and operation modes are input to the camera control CPU 14 by means of the operation switches 6.

Furthermore, the photographing parameters set by the camera control CPU 14 are displayed in an abbreviated fashion in the camera function display 22 on the top side of the digital camera 1.

The camera control CPU 14 is connected to the image processor 10 so as to mutually transmit and receive data. For example, the camera control CPU 14 transmits various parameters to the image processor 10, and receives data regarding the operation status of the image processor 10.

On the other hand, the image processor 10 that performs various types of processing to the image data, which comprises digitized image signals, is realized as a one-chip integrated circuit (IC), and has a pixel interpolation portion 101, a color balance controller 102, a gamma correction portion 103 and an image compressor 104, which perform image processing. These portions transmit and receive data to and from the bus line 110, to which are connected a CPU 111 to perform various calculations, a ROM 112 to store the basic program, and a RAM 113 that comprises the work area.

Furthermore, a video encoder 121 to display the image in the monitor 21, a memory card driver 122 to record the image data in a memory card, and an image memory 13 to temporarily store the image data obtained through photographing, are connected to the bus line 110. The memory card driver 122 and the two card slots 41a and 41b function to record the image data in the memory cards 40a and 40b, as well as to read the image data from the memory cards 40a and 40b.

The portions relating the image processor 10 will now be explained.

The image memory 13 is a memory in which the image data input to the image processor 10 is temporarily stored. The image data stored in the image memory 13 is subjected to image processing.

The pixel interpolation portion 101 reads the image data from the image memory 13. After masking the image data by means of a filter pattern of the primary color filters, for values of G, for which there are more pixels than exist for R or B, such that signals up to high frequency bands may be output, the value for a missing G pixel is deemed the average of the middle two values of the output values from the four pixels surrounding the missing G pixel, based on interpolation by means of a median filter, while the value for a missing R or B pixel is deemed the average value of its surrounding pixels.

The color balance controller 102 performs white balance adjustment by independently performing gain correction to the data of each color component generated through the pixel interpolation. Specifically, it presumes the area in the image that is deemed to be originally white based on the brightness and saturation, seeks the average value of this area for each color component, sets the G/R ratio and G/B ratio of the average values as the correction gains for R and B, respectively, and performs automatic adjustment of the white balance using the correction gains (auto white balance).

The gamma correction portion 103 performs non-linear conversion compatible with the output device (such as the monitor 21 or a general display, for example) on the image data that has undergone white balance adjustment.

The image compressor 104 performs image compression using the JPEG system when the image data in the image memory 13 is saved in the memory card, in order to reduce the amount of image data. It also performs expansion of the compressed image data.

The video encoder 121 encodes the image data stored in the image memory 13 into NTSC or PAL system data, and causes the monitor 21 to perform preview display of the image. In the case of a digital camera that has a separate electronic view finder, the preview display may be performed in the electronic view finder.

The memory card driver 122 is a component that transmits data to and from a memory card. Where the user instructs that the image data be saved, the image data in the image memory 13 is compressed by the image compressor 104 and is saved in the memory card via the card slot. Conversely, where reading of image data from the memory card is instructed, the image data is read from the memory card by the memory card driver 122. After it is expanded by the image compressor 104, the image data is stored in the image memory 13. Through this operation, the image data read from the memory may be displayed in the monitor 21.

The memory card is not limited to a recording medium using a semiconductor memory, but may instead comprise a recording medium using a magnetic disk or magneto-optical disk.

The CPU 111, ROM 112 and RAM 113 in the image processor 10 are components that control the various operations of the digital camera 1. Setting of photographing parameters of the digital camera 1 and image display are performed by means of the CPU 111 executing calculations using the RAM 113 as a work area based on the basic program stored in the ROM 112. While FIG. 6 shows the processors 101 through 104 as blocks comprising dedicated electric circuits, the functions of any (or part of any) of the processors 101 through 104 may be realized by means of the CPU 111, ROM 112 or RAM 113. Conversely, any of the functions realized by the CPU 111, ROM 112 and RAM 113 may be separated and realized by a dedicated electronic circuit.

As explained above, the digital camera 1 has two card slots 41a and 41b, enabling the mounting of two memory cards 40a and 40b. The image reproduction operation of the digital camera 1 that uses the recording area of the memory card 40a or 40b will now be explained. The image reproduction operation is realized by means of the CPU 111 performing display control via the video encoder 121 based on the program stored in the ROM 112. These portions control the display of the monitor 21.

In the following explanation, where it is necessary to distinguish the two card slots from each other, they will be referred to as the first card slot 41a and second card slot 41b, and the memory cards mounted in the first and second card slots 41a and 41b will be referred to as the first memory card 40a and the second memory card 40b, respectively.

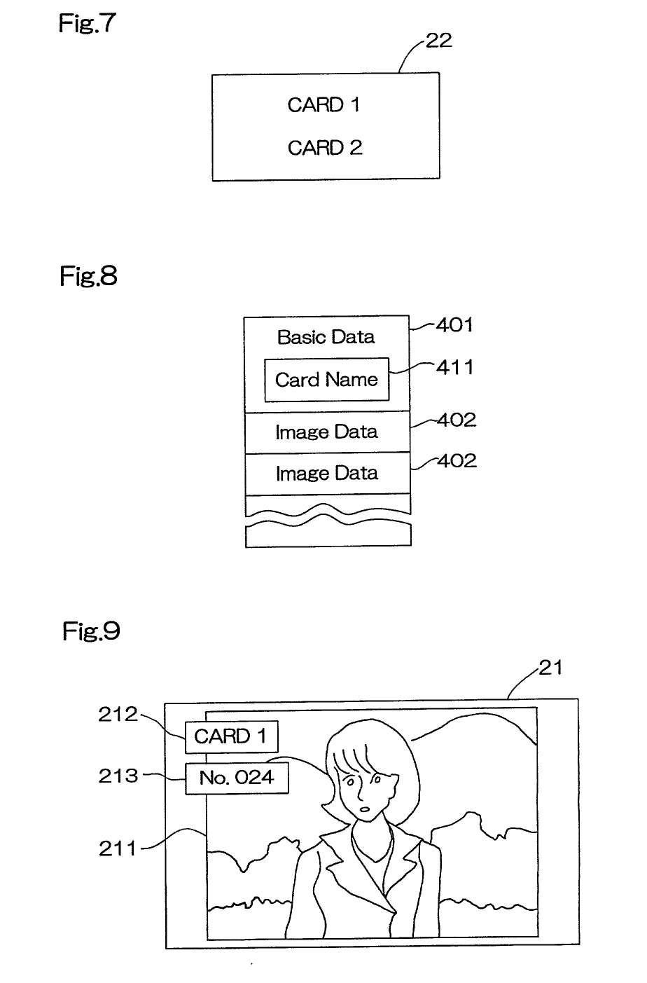

FIG. 7 shows an example of display in the camera function display 22 where memory cards are mounted in the two memory card slots and the reproduction mode is activated. In FIG. 7, the upper ‘CARD1” indicates the card name of the first memory card 40a, while the lower “CARD2” indicates the card name of the second memory card 40b.

These card names are assigned by being recorded in each memory card in advance, so that when the memory card is mounted in the digital camera 1, the card name is automatically read. FIG. 8 shows the construction of the data in the memory card in a simplified fashion, showing how the card name 411, the file name of each item of image data (these are file names corresponding to the frame number, for example, and will be referred to below as the ‘image number’), basic data 401 including the address in which each item of image data resides and the recording time for each item of image data, and multiple items of image data 402 obtained through photographing are recorded in the memory card.

As described above, the digital camera 1 has a single image display mode in which a single image is reproduced and displayed in the monitor 21, and a dual image display mode in which two images are reproduced and displayed simultaneously. Switching from one display mode to another is performed by means of the alternating switch 61. These display modes are explained below.

FIG. 9 shows an example of the display in the monitor 21 when the single display mode is active. As shown in FIG. 9, one image 211 is shown in the monitor 21, as well as the card name 212 in which the data for the image 211 is recorded and the image number 213 for the image 211. By displaying this information, the user may easily and clearly determine the memory card in which the reproduced image data is stored, and as a result, erroneous operation, such as the unintended deletion of an image, may be prevented.

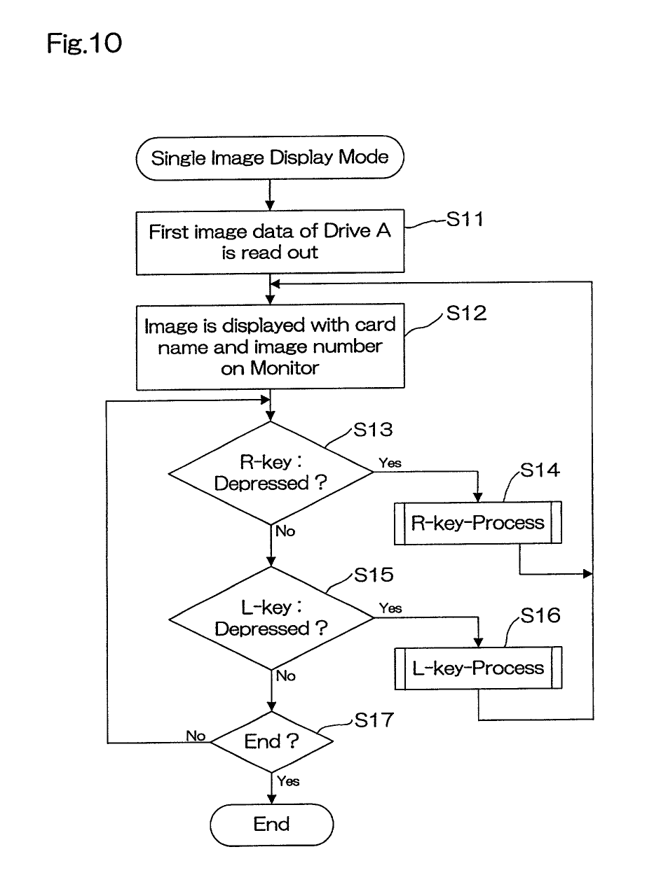

FIGS. 10 through 12 are flow charts showing the outline of the sequence of the operation of the digital camera 1 when the single image display mode is active. In the explanation below, the first memory card 40a is recognized as drive A and the second memory card 40b is recognized as drive B in the digital camera 1.

When the mode is switched to the single image display mode, drive A is set as the current drive, which is the drive to be accessed. The image data for the first image number in drive A is then read, and after the image data is expanded, it is stored in the image memory 13 (step S11). The card name and image number, as well as the image based on the image data, are then displayed in the monitor 21 (step S12). It is also acceptable if the card name and image number are superimposed on the image, or if they are displayed after a synthesized image is generated.

If the right key (hereinafter the ‘R key’) 62d of the four-way keys 62 is pressed here, the image for the next image number (which is not necessarily the next serial number, but refers to the image number to be shown next) is displayed (steps S13, S14). If the left key (hereinafter the ‘L key’) 62c is pressed, the image for the previous image number is displayed (steps S15, S16). These operations are repeated until the single image display mode is ended (step S17).

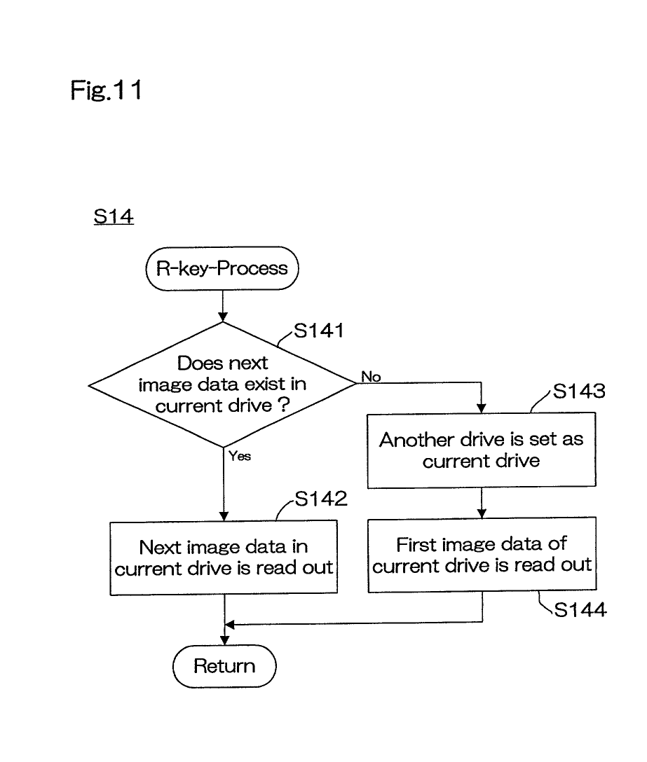

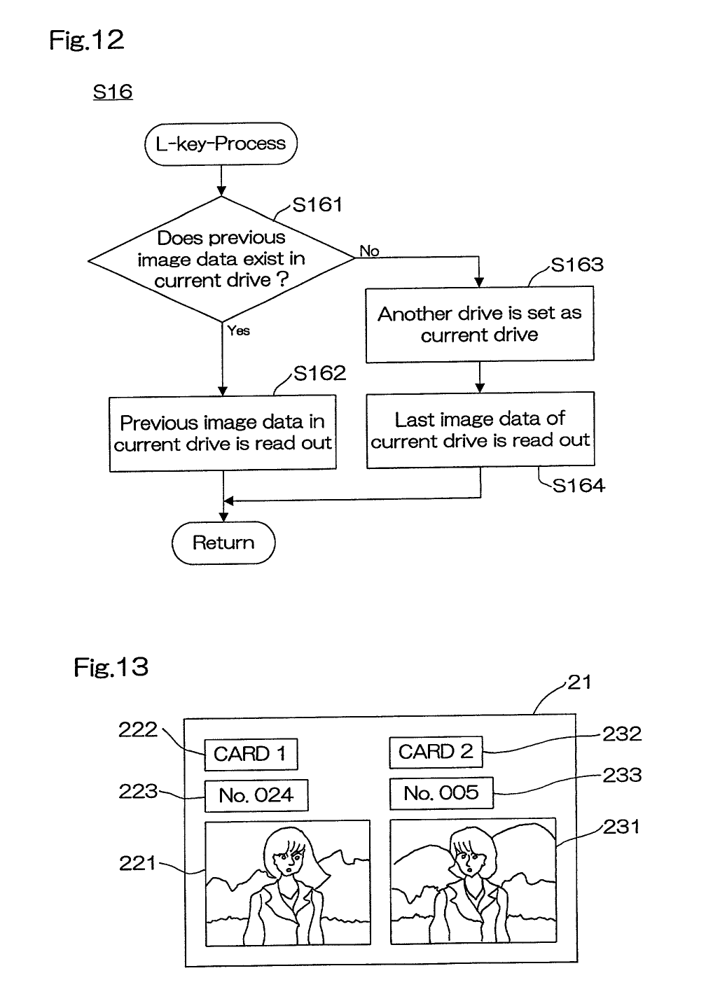

In the digital camera 1, all image data recorded in the two memory cards 40a and 40b is handled as a single group of image data items based when the R key 62d or L key 62c is pressed. FIGS. 11 and 12 are flow charts showing the sequence when the R key 62d or L key 62c is pressed, respectively.

When the R key 62d is pressed, it is first determined whether or not image data for the next image number exists in the memory card of the current drive (step S141), and where a next image data item exists, this image data is read into the digital camera 1 (step S142). Step S12 is then returned to, and the image, card name and image number are displayed in the monitor 21 based on the read image data.

Where there is no next image data item in the memory card of the current drive, the other drive is deemed the current drive (step S141, S143), and the image data for the first image number in the new current drive, i.e., the other memory card, is read into the digital camera 1 (step S144). Consequently, the first image data item of one memory card is handled as the next image data item for the last image data item of the other memory card.

Where the L key 62c is pressed, it is first determined whether or not image data for the previous image number exists in the memory card of the current drive (step S161). Where a previous image data item exists, this image data is read into the digital camera 1 (step S162). Step S12 is then returned to and the image, card name and image number are displayed in the monitor 21 based on the read image data.

Where there is no previous image data item in the current drive, the other drive is deemed the current drive (steps S161, S163), and the image data for the last image number in the current drive, i.e., the other memory card, is read into the digital camera 1 (step S164). Consequently, the last image data item in one memory card is handled as the image data item prior to the first image data item of the other memory card.

As described above, in the digital camera 1, at least one item of image data recorded in the first memory card 40a and at least one item of image data recorded in the second memory card 40b are handled as if they were multiple items of image data recorded in a single large-capacity memory card. Consequently, erroneous operation in image reproduction may be prevented. In addition, image searches may be efficiently performed through a small number of steps.

In the operation explained above, the first image data item of the first memory card 40a is handled as the image data item following the last image data item of the second memory card 40b, but this need not always be the case. In other words, a group of image data items recorded in the first memory card 40a and the second memory card 40b may be handled as if the group begins with the first image data item in the first memory card 40a and ends with the last image data item in the second memory card 40b.

In other words, by aligning the multiple items of image data recorded in the memory cards in the order of the first memory card 40a and the second memory card 40b (i.e., by specifying the image data items immediately before and after a particular item of image data in this order), the items of image data recorded in the two memory cards may be handled with accuracy as if they comprised image data items recorded in a single memory card.

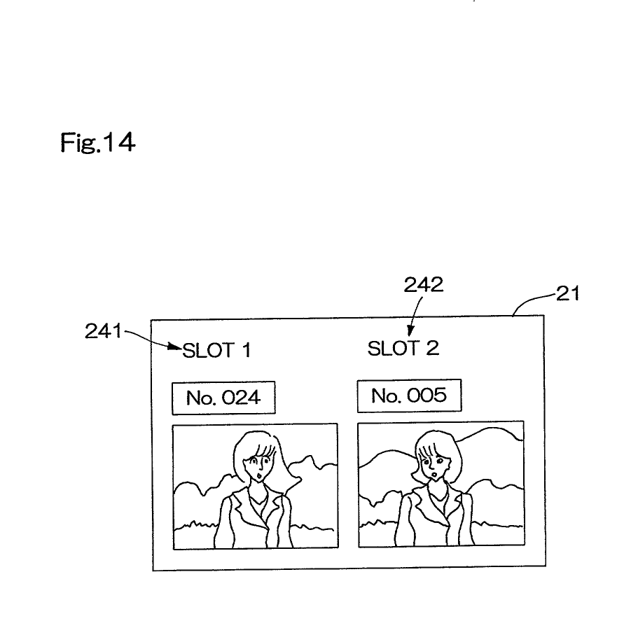

FIGS. 13 and 14 show examples of the display in the monitor 21 when the dual image display mode is active. In FIG. 13, the image 221 based on the image data read from the first memory card 40a, as well as the card name 222 and image number 223, is displayed on the left side of the screen, while the image 231 based on the image data read from the second memory card 40b, as well as the card name 232 and image number 233, is displayed on the right side of the screen. As shown here, in the dual image display mode, the images from each memory card are displayed at prescribed positions on the screen of the monitor 21. In addition, since the card name and image number are displayed such that they are associated with each image, the user may easily identify the memory card from which the image was reproduced. As a result, mistaken recognition and erroneous operation may be prevented, and the image data may be handled with accuracy.

It is acceptable if the card slot number is displayed in place of the card name, as indicated by the numbers 241 and 242 in FIG. 14. The slot number may be similarly displayed in the single image display mode as well. Based on the slot number, the left image in FIG. 14 can be recognized as an image read from the first memory card 40a mounted in the first card slot 41a (more accurately, it is an image displayed based on the read image data, but such a simplified expression may be used where necessary), and the right image may be recognized as an image read from the second memory card 40b mounted in the second card slot 41b. The information displayed with the image in this fashion may be any information that can as a practical matter specify the memory card, such as the name assigned to the memory card, or the slot number.

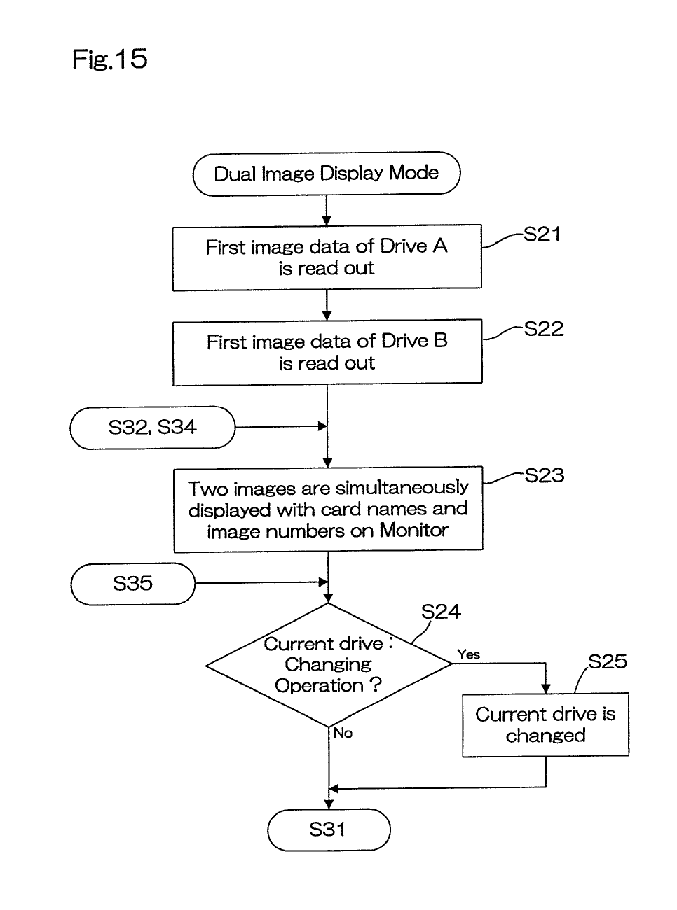

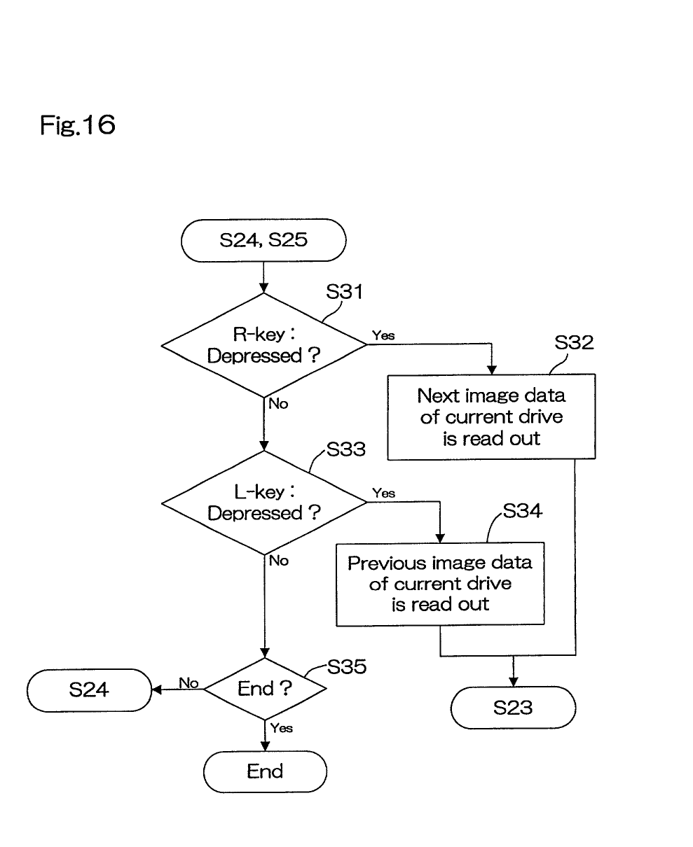

FIGS. 15 and 16 are flow charts showing an outline of the sequence of the operation of the digital camera 1 when the dual image display mode is activated.

When the alternating switch 61 is switched to the dual image display mode, the first image data item in drive A (i.e., the first memory card 40a) is read, and the first image data item in drive B (i.e., the second memory card 40b) is read (steps S21, S22). Two images based on the two items of image data thus read are then displayed in the monitor 21 together with their corresponding card name and image number, as shown in the example of FIG. 13 (step S23). When this occurs, it is assumed that the current default drive is set to be drive A, and the current drive is indicated to the user by using a different color for the display of the card name of the memory card in the current drive.

When the two images are displayed, the camera enters a standby state in which it waits for a change in the current drive or for the operation of the R key 62d or L key 62c (steps S24, S31, S33, S35). When the user presses either the key 62a or 62b and the current drive is changed (step S24), the memory card to be accessed in the digital camera 1 is changed (step S25). Where the R key 62d is pressed, the next image data item in the current drive is read (steps S31, S32), and step S23 is returned to so that the image is displayed again.

If the R key 62d is pressed when the current drive is drive A (card name ‘CARD1’) in FIG. 13, for example, the left image is replaced by the image for the next image number in the first memory card 40a, and the image number display is also updated. Where the current drive is drive B (card name ‘CARD2’), if the R key 62d is pressed, the right image is replaced by the image for the next image number in the second memory card 40b, and the image number display is also updated.

On the other hand, where the L key 62c is pressed, the previous image data item in the current drive is read (step S33, S34), and step S23 is returned to so that the image is displayed. Through this routine, the image and image number for the current drive are updated in FIG. 13.

Where the L key 62c is pressed while the first image of the current drive is being displayed or where the R key 62d is pressed while the last image is being displayed, the display need not be updated. The next image data item after the last image data item may be handled as the first image data item in this case.

As described above, the images for each drive, i.e., the images from each memory card, are simultaneously displayed in the monitor 21 when the dual image display mode is active. Incidentally, it is not necessary that the images on both sides be displayed exactly at the same time. It is sufficient so long as they are displayed at essentially the same time or essentially simultaneously. ‘Essentially simultaneously’ here means that both images are being displayed at least at the same point in time (which applies below as well). Based on this display, the user can easily identify the memory card from which the displayed image is read, and accurate image data operation may be performed.

To summarize the explanation provided above, while two memory cards may be mounted in the digital camera 1, all of the image data recorded in the two memory cards is handled as one group of image data items in the single image display mode, and the images based on the image data from each of the two memory cards are displayed essentially simultaneously in the dual image display mode. Consequently, mistaken recognition of the image data or erroneous operation may be prevented, and the image data may be handled accurately.

In addition, because the information that specifies the memory card in which the image data for the displayed image is stored is displayed in the monitor 21 regardless of which image is displayed, the image data may be handled with increased accuracy.

<2. Second Embodiment>

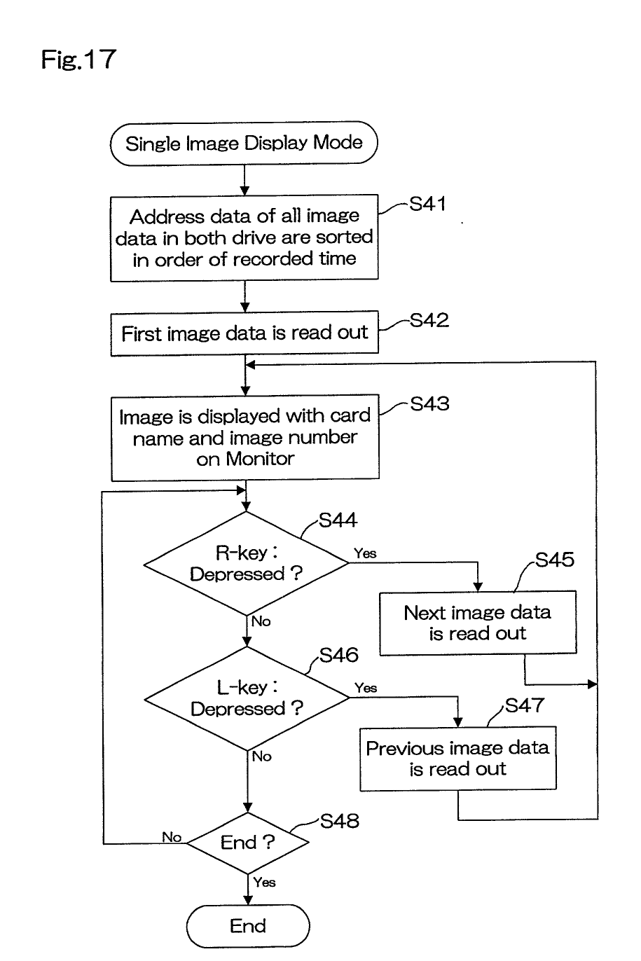

Another example of the single image display mode in the digital camera 1 having the construction shown in FIGS. 1 through 6 is explained below as a second embodiment of the present invention. FIG. 17 is a flow chart showing an outline of the sequence of the operation of the digital camera 1 when the single image display mode is active.

First, when the alternating switch 61 is switched to the single image display mode, all of the image data items in both drives are sorted in the ascending order of the recording times (i.e., the photographing times), such that the image data item having the earliest recording time is deemed the first image data item and the image data item having the latest recording time is deemed the last image data item (step S41). This means not that the recording position inside the memory card is changed, but that the post-sorting order of the addresses of each item of image data is generated in the digital camera 1.

The first image data item is then read from either memory card, and the image based on the read image data, as well as the card name for the memory card in which the image data was recorded, and the image number, is displayed in the monitor 21 (steps S42, S43). The camera then enters a standby state in which it awaits the operation of the R key 62d or L key 62c (steps S44, S46, S48).

Where the R key 62d is pressed (step S44), the image data item having the next recording time is read (step S45), and step S43 is returned to, so that the image, card name and image number are displayed. Where the L key 62c is pressed (step S46), the image data item having the previous recording time is read (step S47), and step S43 is returned to, so that the image, card name and image number are displayed.

Where the R key 62d is pressed while the first image is being displayed, or where the L key 62c is pressed while the last image is being displayed, the image display is not changed.

As described above, in the single image display mode pertaining to the second embodiment, all of the image data items recorded in the two memory cards are handled as a group of items of image data arranged in the order of the recording times, and even if the user records the image data in either of the memory cards during photographing without paying attention to the sequence, image reproduction may be performed in the order of photographing. As a result, mistaken recognition and erroneous operation may be prevented, and the image data may be handled with accuracy.

It is also acceptable if the image data items are sorted in the descending order of the recording times in step S41, and if step S41 is omitted and a search for the image data items to be displayed is performed each time in steps S45 and S46.

<3. Third Embodiment>

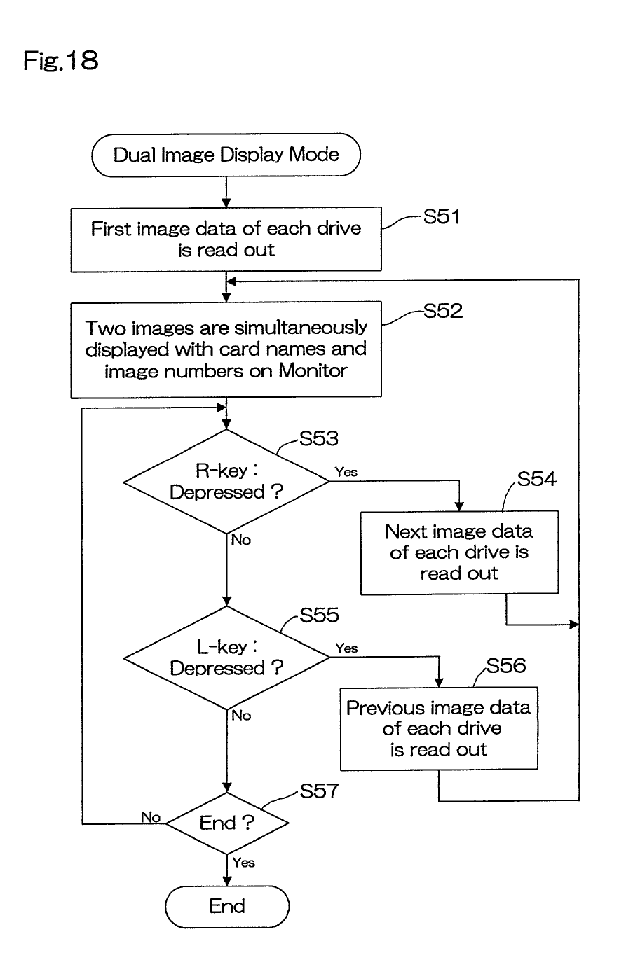

Another example of the dual image display mode in the digital camera 1 having the construction shown in FIGS. 1 through 6 is explained below as a third embodiment of the present invention. FIG. 18 is a flow chart showing an outline of the sequence of the operation of the digital camera 1 when the dual image display mode is active.

In the dual image display mode pertaining to the third embodiment, the image data items for the first image numbers in both drives is read. As in the example shown in FIG. 13, two images together with their respective card names and image numbers are displayed in the monitor 21 side by side (i.e., essentially simultaneously) (steps S51, S52). The camera then enters a standby state in which it awaits the operation of the R key 62d or L key 62c (steps S53, S55, S57).

When the R key 62d is pressed (step S53), the image data item for the next image number is read from both drives (step S54). Step S52 is returned to, and two images based on the two items of image data thus read are displayed together with their respective card names and image numbers.

When the L key 62c is pressed (step S55), the image data for the previous image number is read from both drives (step S56), and two images based on the two items of image data are displayed together with their respective card names and image numbers (step S52)

As described above, in the dual image display mode pertaining to the third embodiment, the images from both drives are displayed essentially simultaneously without the current drive being specified. Therefore, the user may easily determine the memory card from which each of the two images is displayed, and may reproduce them without having to pay attention to the current drive, enabling the accurate handling of image data.

<4. Fourth Embodiment>

In the single image display mode and dual image display mode explained above, one item of image data was read from either memory card or from both memory cards for display in the monitor 21, but it is also possible to display images in the monitor 21 based on two or more items of image data read from one memory card.

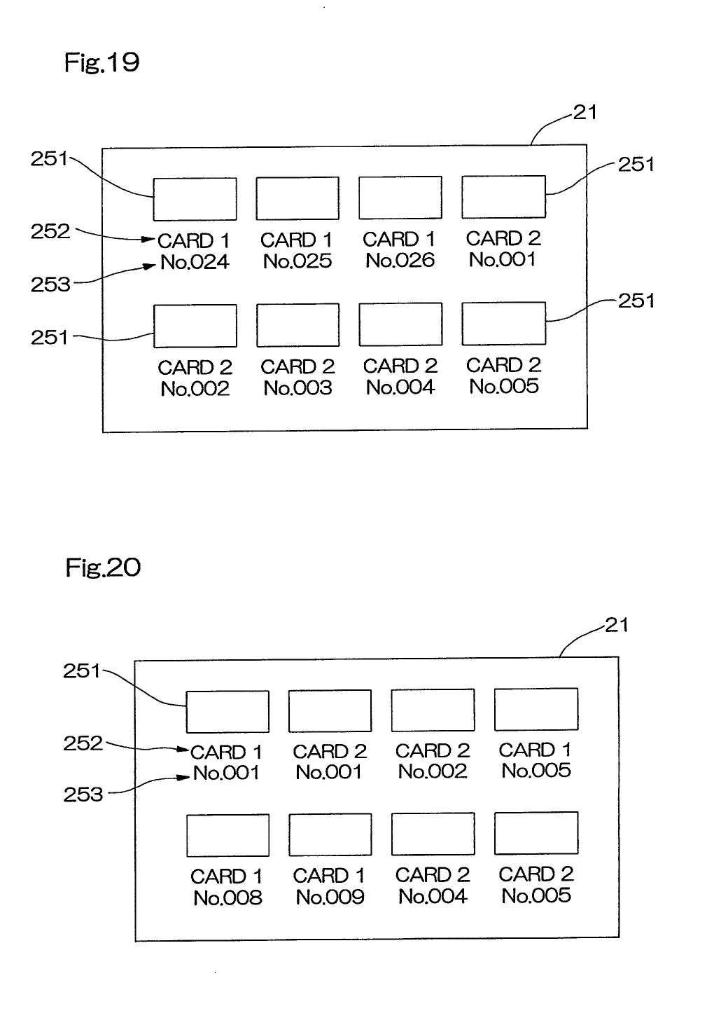

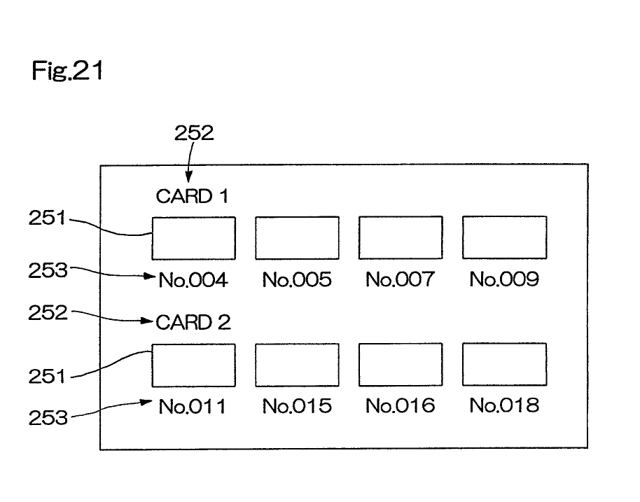

FIG. 19 shows an example of the display in the monitor 21 when the operation in the single image display mode shown with reference to FIGS. 10 through 12 is applied in the display of multiple thumbnail images. In FIG. 19, the order of the thumbnail images 251 begins with the image at the upper left corner and ends with the image at the lower right corner, traveling via the image at the upper right corner and the image at the lower left corner. Each image's corresponding card name 252 and image number 253 are also displayed under the thumbnail image (this is also true in FIGS. 20 and 21 described below). The image with the card name “CARD1” and the image number “No. 026” is the last image in the first memory card 40a, and the next image is the first image in the second memory card 40b, and has the card name “CARD2” and the image number “No. 001”. In other words, the first image data item of the second memory card 40b is handled as the image data item following the last image data item of the first memory card 40a, and all image data items recorded in both memory cards are handled according to the order of the memory cards.

When the R key 62d is pressed, the R key 62d operation shown in FIG. 10 (step S14, FIG. 11) is repeated the number of the thumbnail images that may be displayed, and the next eight thumbnail images are then displayed. On the other hand, where the L key 62c is pressed, the L key operation (step S16, FIG. 12) is repeated the number of the thumbnail images that may be displayed, and the previous eight thumbnail images are displayed. In this way, the number of image data items that are read from one memory card and subjected to display may be two or more.

In order to display the thumbnail images, it is also acceptable if, when the R key 62d or L key 62c is pressed, the same operation as shown in FIG. 10 or FIG. 11 is performed, and a new thumbnail image is added in FIG. 19, replacing another thumbnail that is no longer a subject of display.

FIG. 20 shows an example in which the operation for the single image display mode pertaining to the second embodiment is applied in the display of thumbnail images. In this case, the image data items from both drives are handled in the order of the recording times, and the thumbnail images 251 are displayed in the order of the recording times regardless the drive from which the image was derived, as shown in FIG. 20. When the R key 62d or L key 62c is pressed, the image data items are processed in the order of their recording times, and at least one thumbnail image is replaced with a new one.

FIG. 21 shows an example of the display in the monitor 21 where the operation for the dual image mode pertaining to the first embodiment is applied in the display of thumbnail images. In FIG. 21, the upper row comprises thumbnail images 251 from the first memory card 40a, while the lower row comprises thumbnail images 251 from the second memory card 40b. When the R key 62d or L key 62c is pressed, at least one thumbnail image from the current drive is replaced with a new one.

Naturally, the dual image display mode pertaining to the third embodiment may be applied in the display of thumbnail images. In this case, when the R key 62d or L key 62c is pressed, at least one thumbnail image in the upper row, which was derived from the first memory card 40a, and at least one thumbnail image in the lower row, which was derived from the second memory card 40b, are replaced with a new image in FIG. 21.

As described above, the operation regarding the single image display mode or the dual image display mode pertaining to the first through third embodiments may be applied in the display of multiple thumbnail images. All image data items in both memory cards are handled as one group of image data items in a prescribed order in this case as well. Alternatively, the thumbnail images are displayed at prescribed positions assigned for each memory card, so that the user can handle the image data with accuracy.

In addition, since in FIGS. 19 through 21 as well, the thumbnail images are displayed in such a way that their associated card name and image number are displayed together with the image, the image data may be handled with increased accuracy.

<5. Variations>

As described above, the present invention is not limited to the embodiments described above, but may be implemented in various other variations.

For example, in the embodiments described above, the recording medium in which the image data is recorded is not limited to a memory card. An internal memory may function as the recording medium. In other words, the present invention may be used in a digital camera that has two or more internal memories or in a digital camera that has an internal memory and a card slot. Further, the number of memory cards that may be mounted may be three or more.

Where the number of recording media is three or more, a mode in which the images from each recording medium are displayed essentially simultaneously may be used in place of the dual image display mode.

It is also not necessary to switch between the single image display mode and the dual image display mode. The digital camera may have only one of either of the display modes.

In the single image display mode of the first and second embodiments, the image data item to be displayed when the R key 62d or the L key 62c is operated is specified in accordance with the order of the memory cards or the recording times, but the order of display of all of the image data items recorded in both memory cards may be based on other standards. For example, where multiple items of image data are classified into categories, they may be handled in the order of the categories. The image data handled in the single image display mode is not limited to all of the image data recorded in the recording media, but may be limited to a part of the image data recorded. For example, only image data that was obtained under specific imaging conditions, such as the operation parameters of the digital camera or image quality, or only image data belonging to a specific category, may be subject to display.

Using the construction described above, the user can easily specify the recording medium from which the image data was derived by observing the display, enabling the user to handle the image data with accuracy.

The recording medium from which the image data was derived may be easily specified based on the display of the name assigned to the recording medium or on the display of the information that indicates the card slot.

In the construction described above, the images based on the image data items read from each recording medium are displayed essentially simultaneously, enabling the image data to be handled with accuracy.

The recording medium from which the image data was derived may be easily specified by means of the user's observation of the display.

In the construction described above, the two or more items of image data recorded in two or more recording media are handled in an order based on a prescribed rule, enabling the image data to be handled with accuracy.

The image data may be handled with accuracy based on the order of the recording times or on the order of the recording media.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A digital camera comprising:
a reader that can read image data from two or more recording media;
a display which performs display of the image; and
a display controller which causes said display to display the information that specifies the recording medium from which the image data was read as well as the image based on the image data.

2. A digital camera according to claim 1, wherein the information which specifies the recording medium comprises a name that is assigned to the recording medium.

3. A digital camera according to claim 1, further comprising two or more card slots, and the recording media are memory cards mounted in these card slots.

4. A digital camera according to claim 3, wherein the information which specifies the recording medium is information that indicates the card slot in which the memory card is mounted.

5. A digital camera comprising:
a reader which reads image data from a first recording medium and a second recording medium;
a display which performs display of the image; and
a display controller which causes said display to display essentially simultaneously a first image based on the image data read from the first recording medium and a second image based on the image data read from the second recording medium.

6. A digital camera according to claim 5, wherein said display controller causes said display to display the information that specifies the first recording medium in a manner such that it is associated with the first image, and causes said display to display the information that specifies the second recording medium in a manner such that it is associated with the second image.

7. A digital camera comprising:
a reader which can read image data from any of two or more recording media;
a display which performs display of the image; and
a display controller that, by handling a plurality of items of image data recorded in the two or more recording media in sequence based on a prescribed rule, causes said display to sequentially display the plurality of images in accordance with the sequence.

8. A digital camera according to claim 7, wherein the sequence based on the prescribed rule is the ascending or descending order of the recording times for the plurality of items of image data.

9. A digital camera according to claim 7, wherein the sequence based on the prescribed rule is the sequence in accordance with the predetermined order of the two or more recording media.

10. A digital camera according to claim 7, wherein said display controller causes said display to display the information that specifies the recording medium from which the image data was read together with the image displayed based on image data.

11. An image display method in a digital camera comprising:
reading image data from one of two or more recording media; and
displaying an image based on the image data and the information that specifies the recording medium from which the image data was read.

12. An image display method in a digital camera comprising:
reading image data from a first recording medium and a second recording medium; and
displaying the first image based on the image data read from the first recording medium and the second image based on the image data read from the second recording medium, essentially simultaneously.

13. An image display method in a digital camera comprising:
reading one item of image data from a plurality of items of image data stored in two or more recording media;
displaying an image based on the one item of image data; and
specifying the next item of image data following the displayed item of image data in accordance with the sequence of the plurality of items of image data based on a prescribed rule when the image following the displayed image is designated, whereas specifying the image data item prior to the displayed item of image data in accordance with said sequence when the image prior to the displayed image is designated.
